(19) United States
(12) Patent Application Publication
(10) Pub. No.: US 2005/0284301 A1
(43) Pub. Date: Dec. 29, 2005

(54) Water cleaning dust-filtering device

(76) Inventors: Rong-Yuan Tseng, Taipei Hsien (TW); Kuo-I Lin, Taipei Hsien (TW)

Correspondence Address: TSENG, RONG-YUAN, 235 CHUNG-HO BOX 8-24, TAIPEI HSIEN, 235, TW

(21) Appl. No.: 10/873,443

(22) Filed: Jun. 23, 2004

(51) Int. Cl. B01D 47/02

(52) U.S. Cl. 96/337

(57) ABSTRACT

A water cleaning dust-filtering device comprises a casing being a long hollow container; a bottom thereof being formed with a round hole; an L shape tube installed in the casing; a stopper being isolated into an upper chamber and a lower chamber; the stopper being a folded plate; a lower cover movably installed to a lower end of the casing; an interior of the lower cover having a dust-collector groove; an upper cover movably installed to a top end of the casing; a top thereof having an outlet; a first filter net installed with the dust-collector groove of the lower cover for filtering larger scale particles; and a second filter net for filtering water particles and the filter net being installed in the opening of the upper cover and a joint installed in the outlet of the upper cover; and a joint connected to a guide tube of a vacuum cleaner.

### FIELD OF THE INVENTION

The present invention relates to filtering devices, and particular to water cleaning dust-filtering device used for various vacuum cleaners, wherein the motor of the vacuum cleaner will not be wetted and thus is not destroyed since the water molecules are drained from a guide hole of a stopper.

### BACKGROUND OF THE INVENTION

Most of the prior art washing form vacuum cleaner has dust-washing device installed in the vacuum cleaner. However, as shown in FIGS. 7, and 8, it is illustrated that a prior art mop for filtering dusts is developed.

Referring to FIG. 7, an assembled perspective view of a filter of a vacuum cleaner is illustrated. FIG. 8 is a schematic cross view showing the operation of a prior art vacuum cleaner. The prior art vacuum cleaner includes a casing 1, a lower cover 2, a central tube 3, a filter net 4, an upper cover 5, a sliding tube 6, etc. A top of the central tube 3 in the casing 1 has an outlet 32. A periphery of the central tube 3 has the filter net 4. A lower end of the casing 1 is sealed by the lower cover. An upper end of a connecting tube 21 of the lower cover is connected to a central tube 3 and a lower end thereof is connected to an air guide tube 92. A top end of the casing is sealed by an upper cover 5. A center of the upper cover is installed with the sliding tube 6. A top of the sliding tube is connected to a guide tube 91 of the vacuum cleaner by the joint 8. Thereby, when the sliding tube 6 moves upwards, the bottom of the tube will separate from the outlet 32 at the top of the central tube 3. When the sliding tube 6 moves downward, the bottom of the tube will seal the outlet 32 of the central tube 3. Furthermore, a hollow portion of the casing 1 can store water or clean agent.

External air flows into the central tube 3 from the air guide tube 92 and then into the hollow casing from the outlet 32. Since the outlet 32 faces to the lateral wall of the casing, the airflow will be turbulent. Large particles will be stayed temporarily due to the filter net 4 and then flows into a dust-collecting bag of the vacuum cleaner through the sliding tube 6. Thus large particles are collected. Small particles, such as dusts, sands, and hairs are sucked by water in the lower chamber, i.e. the portion of the casing below the filter net. Then they are sunk to the bottom of the water due to the vibration of the guide tube and the agitation of water.

In the prior art, the casing 1 is a hollow container. The casing 1 is divided into an upper and a lower chamber by the filter net 4 in the lower edge of the outlet 32 of the central tube 3. The volume of the upper chamber is larger than that of the lower chamber. The outlet 32 is above the filter net 4. When the vacuum cleaner 20 is actuated, part of small particles will move to be below the filter net with the airflow. Since small particles are light, they will solve in water with the vibration of the vacuum cleaner so as to have washing and filtering effects. However, since the airflow flow in the lower chamber in force so that the liquid in the lower chamber is agitated, but part of airflow in the upper chamber will be sucked by the vacuum cleaner. Thereby, the liquid cannot be wholly in contact with the small particles. Thus, some airflow vents out without washing and filtering and then air flows into the dust-collector bag of the vacuum cleaner. Therefore, the effect of washing is not preferred.

Moreover, the vibration of the guide tube of the vacuum cleaner will cause the water molecules are sucked into the vacuum cleaner with the airflow. Thus, the motor in the vacuum cleaner is destroyed and wears.

### SUMMARY OF THE INVENTION

Accordingly, the primary object of the present invention is to provide a water cleaning dust-filtering device, wherein the motor of the vacuum cleaner will not be wetted and thus not to destroyed since the water molecules are drained from a guide hole of a stopper.

Another object of the present invention is to provide water cleaning dust-filtering device, wherein the dust and particles in the air vented from the vacuum cleaner is reduced since the larger particles and small particles are separately filtered.

A further object of the present invention is to provide water cleaning dust-filtering device, wherein the dust-collector bag of the vacuum cleaner is not sealed so that the lifetime of the bag is prolonged. The times for updating the dust-collector bag are reduced and the vacuum cleaner has a preferred suction force.

A yet object of the present invention is to provide water cleaning dust-filtering device, wherein the joint of the water cleaning dust-filtering device can be used with guide tubes of various vacuum cleaners.

A still object of the present invention is to provide a water cleaning dust-filtering device, wherein since clean agent is placed in the casing, the draining air has no foul smell.

To achieve above objects, the present invention provides a water cleaning dust-filtering device comprises: a casing being a long hollow container; a bottom thereof being formed with a round hole having a water-proof washer at an upper side of the round hole and an upper end thereof having a top opening; liquid of water or clean agent being stored in casing; an L shape tube installed in the casing; one opening at one end of the L shape tube extending from the round hole of the casing and another opening of the L shape tube facing to one lateral wall of the casing; a stopper being isolated into an upper chamber and a lower chamber; the stopper being a folded plate having a guide hole; the stopper being placed in the casing from the top opening of the casing; and a periphery of the stopper being tightly sealed to the casing so that interior of the casing being divided into an upper chamber and a lower chamber; a lower cover movably installed to a lower end of the casing so as to open or close the casing; an interior of the lower cover having a dust-collector groove; a bottom of the dust-collector groove having a hollow inserting hole for being connected to an air guide tube; an upper cover movably installed to a top end of the casing for opening and closing the upper cover; a top thereof having an outlet; a first filter net for filtering larger scale particles; the first filter net being installed within the dust-collector groove of the lower cover; and a second filter net for filtering water particles and the filter net being installed in the opening of the upper cover and a joint installed in the outlet of the upper cover; the joint is connected to a guide tube of a vacuum cleaner.

The various objects and advantages of the present invention will be more readily understood from the following detailed description when read in conjunction with the appended drawing.

### BRIEF DESCRIPTION OF THE DRAWINGS

FIG. 1 is an exploded perspective view of water cleaning dust-filtering device according to the present invention.

FIG. 2 is an assembled perspective view of the water cleaning dust-filtering device of FIG. 1.

FIG. 3 is a whole cross section view of FIG. 2.

FIG. 4 is a schematic view showing the application of the present invention.

FIG. 5 is a schematic view showing the operation of the water cleaning dust-filtering device of the present invention.

FIG. 6 shows the water cleaning dust-filtering device, wherein the upper cover and lower cover are opened.

FIG. 7 is an assembled perspective view the filter of a vacuum cleaner in the prior art.

FIG. 8 is a schematic cross section view showing the water cleaning dust-filtering device will suck dust according to the present invention.

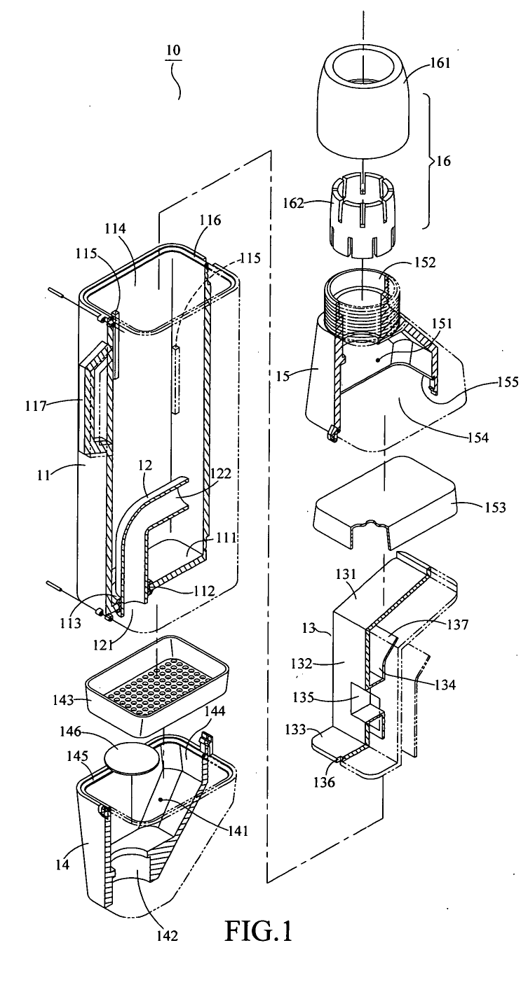

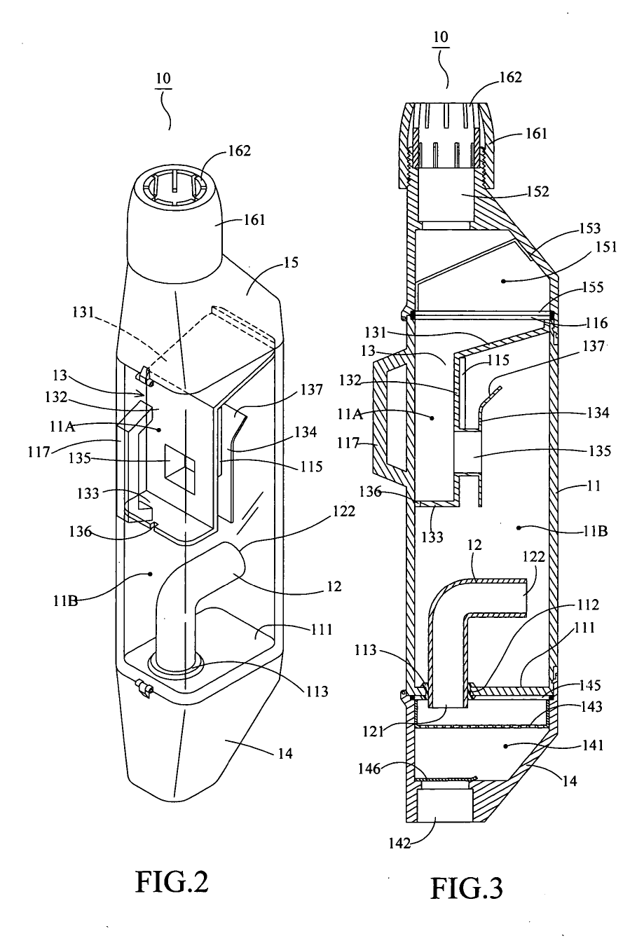

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

Referring to FIG. 3, a whole cross section view about the water cleaning dust-filtering device 10 of the present invention is illustrated. The water cleaning dust-filtering device 10 includes the following elements.

A casing 11 is a long hollow container. A bottom thereof is formed with a round hole 112 having a water-proof washer 113 at an upper side of the round hole 112 and an upper end thereof has a top opening 114. An edge of the top opening 114 is installed with an air-tight tape 116. Inner walls of two sides of the casing 11 are installed with guide strips 115. A handle 117 is installed on the casing 11 for being held by an operator.

An L shape tube 12 is in the casing 11. One opening 121 at one end of the L shape tube 12 extends from the round hole 112 of the casing 11 and another opening 122 of the L shape tube 12 faces to one lateral wall of the casing 11. To receive the L shape tube 12, the retaining ring 1 can not be formed at a center of the bottom 111, but shifts from the center of the bottom.

A stopper 13 is formed by the following way. An inclined plate 131 is connected to a vertical plate 132 and then the vertical plate 132 is connected to a horizontal plate 133. A right side of the vertical plate 132 has a flow guide plate 134. A hollow neck ring 135 serves to connect the vertical plate 132 to the flow guide plate 134. The neck ring 135 is used as a guide hole. An inclined guide plate 137 extends from an upper end of the flow guide plate 134. The stopper 13 is placed in the casing 11 from the top opening 114 of the casing 11. The vertical plate 132 is retained by the guide strips 115 at two sides of the casing 11. End portions of the inclined plate 131 and the horizontal plates 133 resist against an upper and a lower inner walls of the casing 11, respectively. Thereby, the stopper 13 can be positioned and extracted easily. A periphery of the stopper 13 is tightly sealed to the casing 11 so that interior of the casing 11 is divided into an upper chamber 11A and a lower chamber 11B. The upper chamber 11A is an air cleaning chamber and the lower chamber 11B is a washing chamber. The volume of the lower chamber 11B is larger than that of the upper chamber 11A. Besides, one end portion of the horizontal portion is installed with a small notch 136 for drainage, which will be described hereinafter.

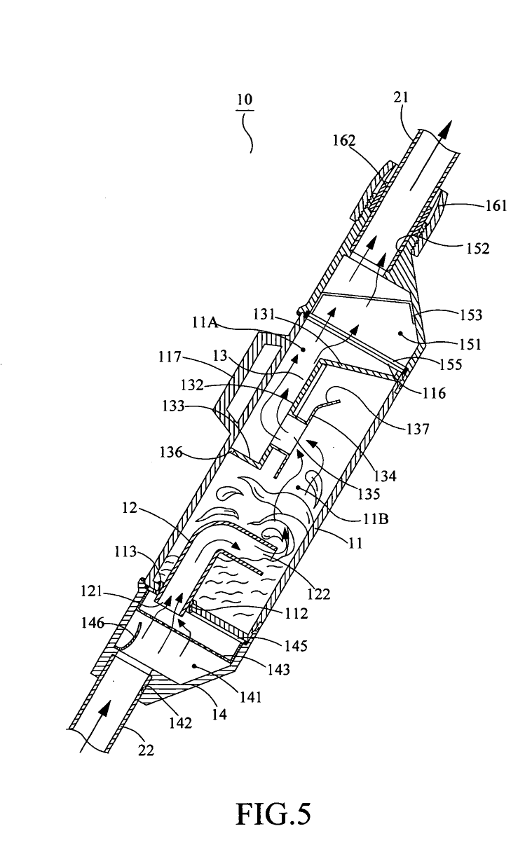

A lower cover 14 is movably installed to a lower end of the casing 11 so as to open or close the casing 11. The lower cover 14 has a tapered shape and an interior of the lower cover 14 has a dust-collector groove 141. A bottom of the dust-collector groove 141 has a hollow inserting hole 142 for being connected to an air guide tube 22, see FIG. 5. A filter net 143 can be placed into an opening 144 of the lower cover 14 for filtering larger scale objects. An air-tight tape 145 is installed at an edge of the opening 144. Furthermore, an edge of the dust-collector groove 141 communicated to the insertion hole 142 can be added with a movable film 146 for sealing the hole.

An upper cover 15 is movably installed to a top end of the casing 11 for opening and closing the upper cover 15. A shape of the upper cover 15 is similar to that of the lower cover 14. An interior of the upper cover 15 has a receiving groove 151 and a top thereof has an outlet 152 for screwing with a joint 16. The upper cover 15 is connected to a guide tube 21 of a vacuum cleaner through the joint 16, see FIG. 5. Furthermore, a filter net 153 is placed into the opening 154 of the upper cover 15 for isolating water particles in airflow. An edge of the opening 154 is installed with an air-tight tape 155.

The joint 16 is formed by a reduced ring 162 in the outlet 152 of the upper cover 15 and a tapered rotatable sleeve 161 enclosing the reduced ring 162 and installed at the outlet 152. By the screwing engagement of the tapered rotatable sleeve 161 and the outlet 152 so as to tighten the reduced ring 162. Therefore, the reduced ring 162 can be tightly engaged to the guide tube 21 (referring to FIG. 5). Furthermore, the retaining of the reduced ring 162 is proportional to the screwing tightness of the tapered rotatable sleeve 161 so that the opening of the reduced ring 162 is reduced. On the contrary, the opening of the reduced ring 162 will expand. Thus, the reducing effect of the reduced ring 162 can be used to the guide tubes 21 of various vacuum cleaners.

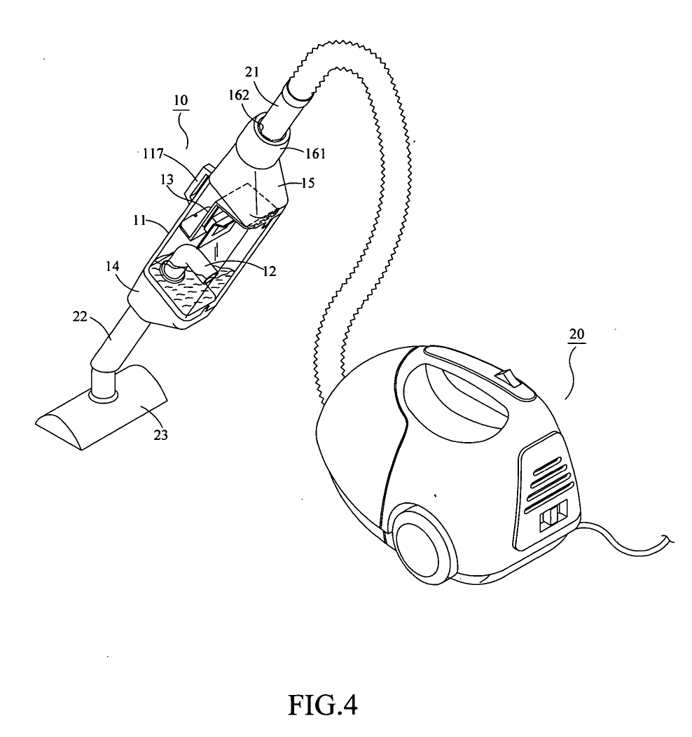

Referring to FIG. 4, the application of the present invention will be described herein. It is shown in the drawing that the water cleaning dust-filtering device 10 is connected to the guide tube 21 of a vacuum cleaner 20 by using the joint 16 at the top end of the upper cover 15. The air guide tube 22 is inserted into the hollow insertion hole 142 of the lower cover 14. Another end of the air guide tube 22 is connected to the mop 23 of the vacuum cleaner 23. It is known that the air guide tube 22 can be as a part of the guide tube.

FIG. 5 is a schematic view showing the operation of the present invention. The casing 11 can be added with water or cleaning agent (about one fourth of the whole volume) for sterilizing or filtering. The water drainage from the casing 11 is indicated by scales on a periphery of the casing 11. When the vacuum cleaner 20 is actuated to have suction force, external air is sucked into the vacuum cleaner 20 through the mop 23 and the air guide tube 22. The airflow will open the film 146 of the lower cover 14 and then into the dust-collector groove 141. Then the airflow is filtered by the filter net 143 so that larger scale particles in the airflow can be isolated in the dust-collector groove 141. The airflow will flow into the casing 11 through the L shape tube 12 since large scale particles has been hindered by the filter net 143. Thereby, only small particles are in the airflow.

In above structure, the operator holds the water cleaning dust-filtering device 10 with the device being obliquely or vertically arranged. Generally, the device is placed obliquely so that the water or clean agent will submerge into the opening 122 of the L shape tube 12 within the casing 11, not to flow out from the L shape tube 12 (in the present invention, the L shape tube 12 can be replaced by a U shape tube). When air is ejected out from the opening 122 of the L shape tube 12. Liquid can be injected into the L shape tube 12 effectively. Thereby, the liquid is turbulent in the lower chamber 11B of the casing 11 due to the airflow. As a result the fine particles, such as dusts, sands, hairs will sink in the water. When the liquid turns, the vapors will not flow into the upper cover 15. The inclined guide plate 137 of the flow guide plate 134 will stop the vapors and reduce the speed of the air flowing through the neck ring 135. Finally, the washed clean air will flow in the upper chamber 1A and then flow into the upper cover 15 to be isolated by the filter net 153 so as to filer the air again. As a result, the water molecules in the air will be left on the filter net 153. Only clean air passes through the filter net 153 to be drained out from the outlet 152. Then the air flows into a dust-collecting bag from the guide tube 21 of the vacuum cleaner. Since no water molecules enter into the vacuum cleaner 20, the motor of the vacuum cleaner 20 is difficult to be destroyed.

Besides, the water molecules isolated on the filter net 153 will collect as small water drops. These water drops will fall into the upper chamber 1A. Then they return to the lower chamber 11B from the notch 136 through the horizontal plate 133. Besides, when the vacuum cleaner 20 trips, the film 146 in the lower cover 14 will seal the open automatically so that the large scale particles in the dust-collector groove 141 will not fall into the guide tube 22.

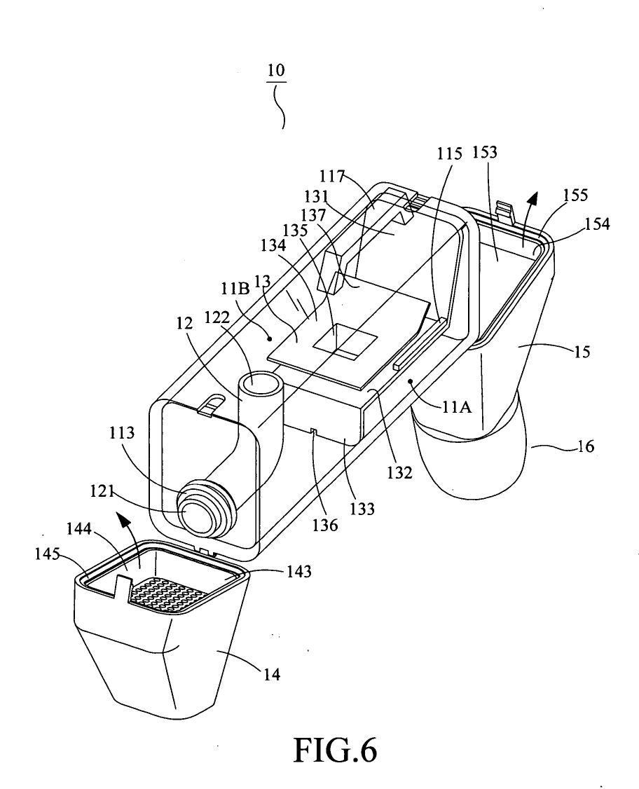

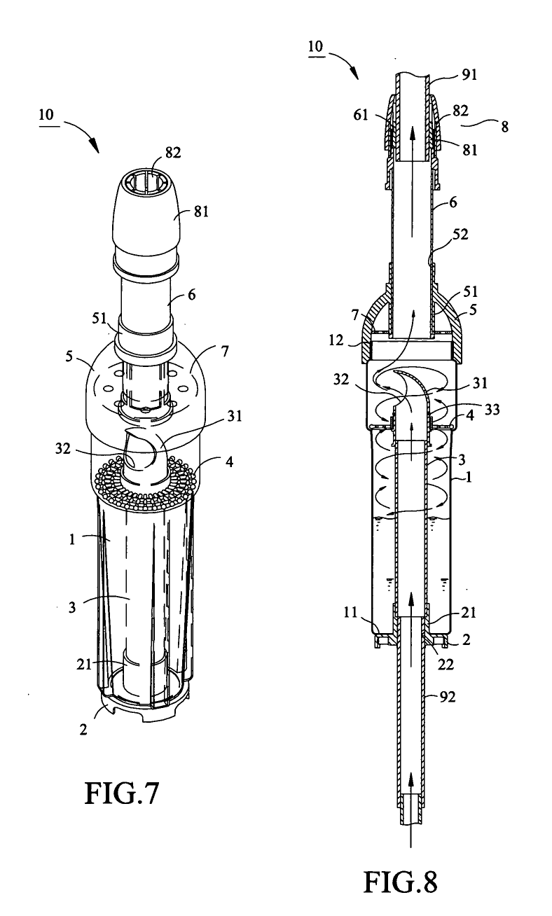

Referring to FIG. 6, a schematic view showing the opening the upper cover and lower cover is illustrated. It is known that the lower cover 14 and the upper cover 15 are screwedly buckled to be movably installed at two ends of the casing 11. Thereby, it is convenient to take the filter net 143 and filter net 153 or to clean the large scale objects in the dust-collector groove 141 or to update the liquid in the casing 11.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A water cleaning dust-filtering device comprising:
a casing being a long hollow container; a bottom thereof being formed with a round hole and an upper end thereof having a top opening; liquid of water or clean agent being stored in casing;
an L shape tube installed in the casing; one opening at one end of the L shape tube extending from the round hole of the casing and another opening of the L shape tube facing to one lateral wall of the casing;
a stopper being isolated into an upper chamber and a lower chamber; the stopper being a folded plate having a guide hole; the stopper being placed in the casing from the top opening of the casing; and a periphery of the stopper being tightly sealed to the casing so that interior of the casing being divided into the upper chamber and the lower chamber;
a lower cover movably installed to a lower end of the casing so as to open or close the casing; an interior of the lower cover having a dust-collector groove; a bottom of the dust-collector groove having a hollow inserting hole for being connected to an air guide tube;
an upper cover movably installed to a top end of the casing for opening and closing the upper cover; a top thereof having an outlet;
a first filter net for filtering larger scale particles; the first filter net being installed within the dust-collector groove of the lower cover; and
a second filter net for filtering water particles and the filter net being installed in the opening of the upper cover and
a joint installed in the outlet of the upper cover; the joint is connected to a guide tube of a vacuum cleaner.

2. The water cleaning dust-filtering device as claimed in claim 1, wherein inner walls at two sides of the casing are installed with guide strips for supporting and retaining the stopper.

3. The water cleaning dust-filtering device as claimed in claim 1, wherein the stopper is formed by an inclined plate, a vertical plate and a horizontal plate; the inclined plate is connected to a vertical plate and then the vertical plate is connected to a horizontal plate.

4. The water cleaning dust-filtering device as claimed in claim 3, wherein a right side of the vertical plate has a flow guide plate; a hollow neck ring serves to connect the vertical plate to the flow guide plate; and the neck ring is used as a guide hole; and an inclined guide plate extends from the flow guide plate.

5. The water cleaning dust-filtering device as claimed in claim 1, wherein one plate of the stopper at a lowest position has a notch for draining water.

6. The water cleaning dust-filtering device as claimed in claim 1, wherein an edge of the dust-collector groove communicated 10 the insertion hole is added with a movable film for sealing the hole.

7. The water cleaning dust-filtering device as claimed in claim 1, wherein the L shape tube is replaced by a reverse U shape tube; one end of the U shape plate is connected to the round hole of the casing and another end of the U shape tube faces to the lateral wall of the casing.

8. The water cleaning dust-filtering device as claimed in claim 1, wherein a handle is added to the casing for being held.
